(19) United States
(12) Patent Application Publication
(10) Pub. No.: US 2008/0198390 A1
(43) Pub. Date: Aug. 21, 2008

(54) Image processing apparatus, image processing method, and program

(75) Inventor: Eiji Tanaka, Sapporo-shi (JP)

Correspondence Address: Edwards Angell Palmer & Dodge LLP, P.O. Box 55874, Boston, MA, 02205, US

(73) Assignee: Seiko Epson Corporation, Tokyo (JP)

(21) Appl. No.: 12/070,128

(22) Filed: Feb. 15, 2008

(30) Foreign Application Priority Data
Feb. 20, 2007 (JP) 2007-040012

(51) Int. Cl. G06F 15/00

(52) U.S. Cl. 358/1.2

(57) ABSTRACT

There is provided an image processing apparatus that lays out a layout image on a template image and outputs a resultant image to a print device. The image processing apparatus includes a template image storing unit that stores the template image, the aspect ratio of the template image, and information representing a resize area that is a part or the whole of the area of the template image and resizes the template image in the vertical or horizontal direction are stored in correspondence with one another, a paper aspect ratio storing unit that stores the aspect ratio of paper in correspondence with the type of the paper used by the print device, a template image designating unit that receives designation of the template image stored in the template image storing unit and displays the designated template image on a display screen, a paper designating unit that receives designation of the type of the paper used for the print device, and a resized template image generating unit that generates a resized template image in which the vertical or horizontal length of the template image is resized in accordance with a resize ratio by calculating at least one resize ratio between a vertical resize ratio and a horizontal resize ratio for matching the aspect ratio of the template image of which designation has been received by the template image designating unit to the aspect ratio of the paper of which designation has been received by the paper designating unit and resizing the resize area of the template image. The template image designating unit displays the resized template image generated by the resized template image generating unit on the display screen.

The entire disclosure of Japanese Patent Application No. 2007-040012, filed Feb. 20, 2007 is expressly incorporated by reference herein.

### BACKGROUND

1. Technical Field

The present invention relates to an image processing apparatus, an image processing method, and a program. In particular, the present invention relates to an image processing apparatus, an image processing method, and a program which lay out a layout image on a template image and output the resultant image to a print device.

2. Related Art

An image processing apparatus that stores templates for each size has been known (for example, JP-A-2005-165790).

However, in the image processing apparatus disclosed in JP-A-2005-165790, there is a problem that individual templates for each paper size should be prepared even in a case where templates of a same format or a same background are used.

### SUMMARY

An advantage of some aspects of the invention is that it provides an image processing apparatus, an image processing method, and a program capable of laying out a layout image on a template image and outputting the resultant image to a print device.

According to a first aspect of the invention, there is provided an image processing apparatus that lays out a layout image on a template image and outputs a resultant image to a print device. The image processing apparatus includes: a template image storing unit that stores the template image, the aspect ratio of the template image, and information representing a resize area that is a part or the whole of the area of the template image and resizes the template image in the vertical or horizontal direction are stored in correspondence with one another; a paper aspect ratio storing unit that stores the aspect ratio of paper in correspondence with the type of the paper used by the print device; a template image designating unit that receives designation of the template image stored in the template image storing unit and displays the designated template image on a display screen; a paper designating unit that receives designation of the type of the paper used for the print device; and a resized template image generating unit that generates a resized template image in which the vertical or horizontal length of the template image is resized in accordance with a resize ratio by calculating at least one resize ratio between a vertical resize ratio and a horizontal resize ratio for matching the aspect ratio of the template image of which designation has been received by the template image designating unit to the aspect ratio of the paper of which designation has been received by the paper designating unit and resizing the resize area of the template image. The template image designating unit displays the resized template image generated by the resized template image generating unit on the display screen. Accordingly, one template image can be commonly used for paper sheets having different aspect ratios. Thus, a plurality of templates of a same form or a same background for each size of paper or each aspect ratio is not required to be stored, and therefore, it is possible to save the amount of a disk by reducing the number of processes for generating and maintaining template images.

The image processing apparatus may further include a resize area extracting unit that extracts the resize area of the template image and stores information representing the extracted resize area in the template image storing unit in correspondence with the template image in a case where the designation of the template image that does not have the information representing the resize area has been received by the template image designating unit, wherein the template image storing unit additionally stores a template image that does not have information representing the resize area. In such a case, the template image can be stored without designating the resize area thereof.

The resize area extracting unit may extract an area in which the layout image is not laid out as the resize area. In such a case, the resize template image can be generated in a speedy manner when the resized template image is generated without resizing the laid-out layout image in a case where the layout image is laid out on the template image.

The resizing template image generating unit may be configured to generate the resized template image in which the vertical length or horizontal length of the template image is resized in accordance with the resize ratio by resizing the resize area of the template image when designation of the paper is received by the paper designating unit in a case where the template image on which the layout image is laid out is displayed on the display screen, and the template image designating unit may be configured to display the resized template image on which the layout image without resizing is laid out on the display screen. In such a case, the resized template image can be generated without resizing a laid-out layout image even in a case where the layout image is laid out on the template image. Accordingly, a favorite image can be used as the template image.

It may be configured that the template image storing unit stores information representing a plurality of resize areas in correspondence with the template image, the resized template image generating unit generates the resized template image in which the vertical length or horizontal length of the template image is resized in accordance with the resize ratio by resizing a resize area of the template image, from among the plurality of resize areas, on which the layout image is not laid out when designation of the paper is received by the paper designating unit in a case where the template image on which the layout image is laid out is displayed on the display screen, and the template image designating unit displays the resized template image on which the layout image is laid out on the display screen. In such a case, the resized template image can be generated without resizing a laid-out layout image in a case where the layout image is laid out on the template image.

According to a second aspect of the invention, there is provided an image processing method for laying out a layout image on a template image and outputs a resultant image to a print device. The image processing method includes: storing the template image, the aspect ratio of the template image, and information representing a resize area that is a part or the whole of the area of the template image and resizes the template image in the vertical or horizontal direction are stored in correspondence with one another; storing the aspect ratio of paper in correspondence with the type of the paper used by the print device; receiving designation of the template image stored in accordance with the storing of the template image and displaying the designated template image on a display screen; receiving designation of the type of the paper used for the print device; and generating a resized template image in which the vertical or horizontal length of the template image is resized in accordance with a resize ratio by calculating at least one resize ratio between a vertical resize ratio and a horizontal resize ratio for matching the aspect ratio of the template image of which designation has been received by the generating of a resized template image to the aspect ratio of the paper of which designation has been received by the receiving designation of the type of the paper and resizing the resize area of the template image. The receiving designation of the template image displays the resized template image generated by the generating of a resized template image on the display screen. Accordingly, same advantages as in the first aspect can be acquired.

According to a third aspect of the invention, there is provided a program for controlling an image processing apparatus that lays out a layout image on a template image and outputs a resultant image to a print device. The program allows the image processing apparatus to perform: a template image storing sequence for storing the template image, the aspect ratio of the template image, and information representing a resize area that is a part or the whole of the area of the template image and resizes the template image in the vertical or horizontal direction are stored in correspondence with one another; a paper aspect ratio storing sequence for storing the aspect ratio of paper in correspondence with the type of the paper used by the print device; a template image designating sequence for receiving designation of the template image stored in accordance with the template image storing sequence and displaying the designated template image on a display screen; a paper designating sequence for receiving designation of the type of the paper used for the print device; and a resized template image generating sequence for generating a resized template image in which the vertical or horizontal length of the template image is resized in accordance with a resize ratio by calculating at least one resize ratio between a vertical resize ratio and a horizontal resize ratio for matching the aspect ratio of the template image of which designation has been received by the template image designating sequence to the aspect ratio of the paper of which designation has been received by the paper designating sequence and resizing the resize area of the template image. The template image designating sequence displays the resized template image generated by the resized template image generating sequence on the display screen. Accordingly, same advantages as in the first aspect can be acquired.

The above-described summary does not enumerate all the aspects of the present invention, and a sub combination of groups of the aspects can constitute the invention.

### BRIEF DESCRIPTION OF THE DRAWINGS

The invention will be described with reference to the accompanying drawings, wherein like numbers reference like elements.

FIG. 1 is an example of a personal computer according to an embodiment of the invention.

FIG. 2 is an example of a block diagram of the personal computer.

FIG. 3 shows an example of the display content of a window according to an embodiment of the invention.

FIG. 4 shown an example of information stored in a template image storing unit according to an embodiment of the invention.

FIG. 5 schematically shows a template image and a resize area of the template image according to an embodiment of the invention.

FIG. 6 shows an example of information stored in a paper aspect ratio storing unit according to an embodiment of the invention.

FIG. 7 is a flowchart showing an example of the operation of the personal computer.

FIGS. 8A to 8D schematically show a template image and resize areas of the template image according to an embodiment of the invention, respectively.

FIG. 9 shows another block diagram of the personal computer.

FIG. 10 is a flowchart showing an example of another operation of the personal computer.

FIGS. 11A and 11B schematically show a template image and resize areas of the template image according to an embodiment of the invention, respectively.

### DESCRIPTION OF EXEMPLARY EMBODIMENTS

Hereinafter, embodiments of the present invention will be described. However, the embodiments described below are not for the purpose of limiting the invention corresponding to the claims. In addition, it cannot be determined that the combinations of all the aspects described in the embodiments are essential as solving means of the invention.

### Embodiment 1

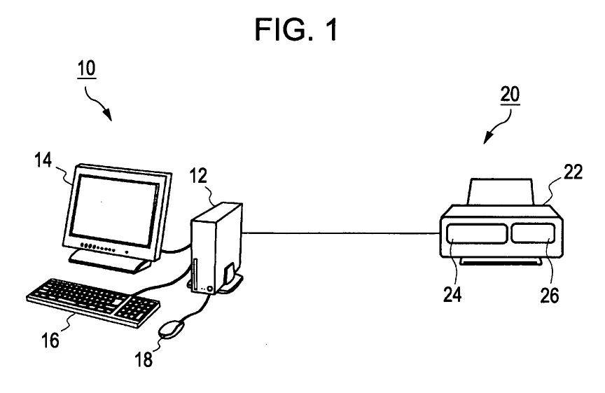

FIG. 1 is an example of a personal computer 10 according to an embodiment of the invention. The personal computer 10 is an example of an image processing apparatus that lays out a layout image on a template image and outputs the resultant image to a print device. The personal computer includes a main body 12, a display 14 that performs a display operation on the basis of an output from the main body 12 for a user, and a keyboard 16 and a mouse 18 as examples of input units for the main body 12 which receive inputs from the user. The personal computer 10 is connected to a printer 20 through a network. The printer 20 is an example of a printing device. The printer 20 includes a main body 22, a display 24 that performs a display operation on the basis of an output from the main body 22 for the user, and an operation panel 26 as an example of an input unit for the main body 22 which receives an input from the user. Here, the template image is an image corresponding to a board art, a background, or the like on which a layout image is laid out. The template image may be designed aesthetically or be a simple white background. The personal computer 10 and the printer 20 may be configured to be separate bodies and connected together through a network or to be an integral body. The personal computer 10 and the printer 20 may be installed to a store for printing photographs.

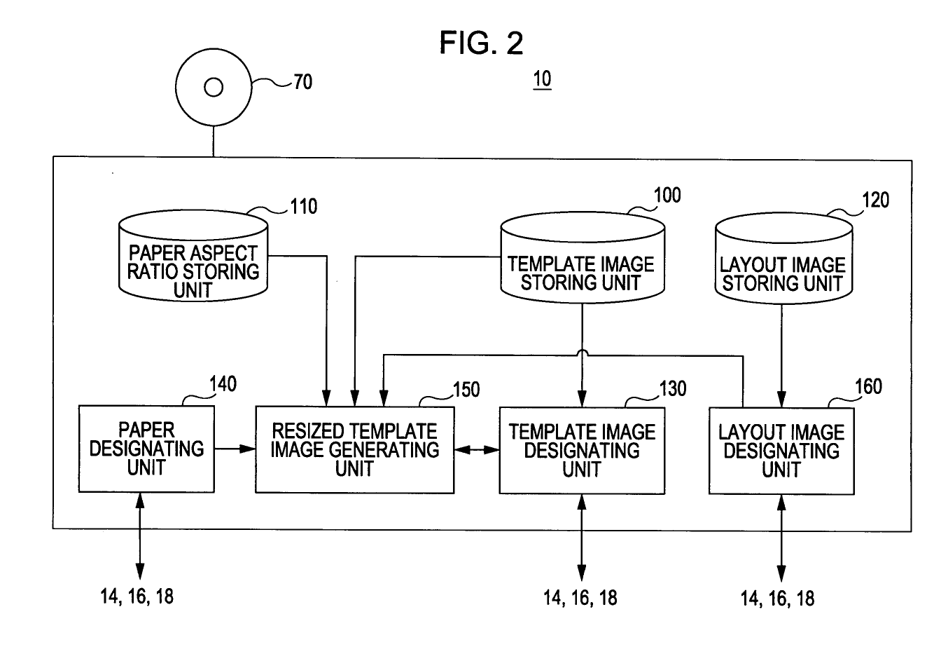

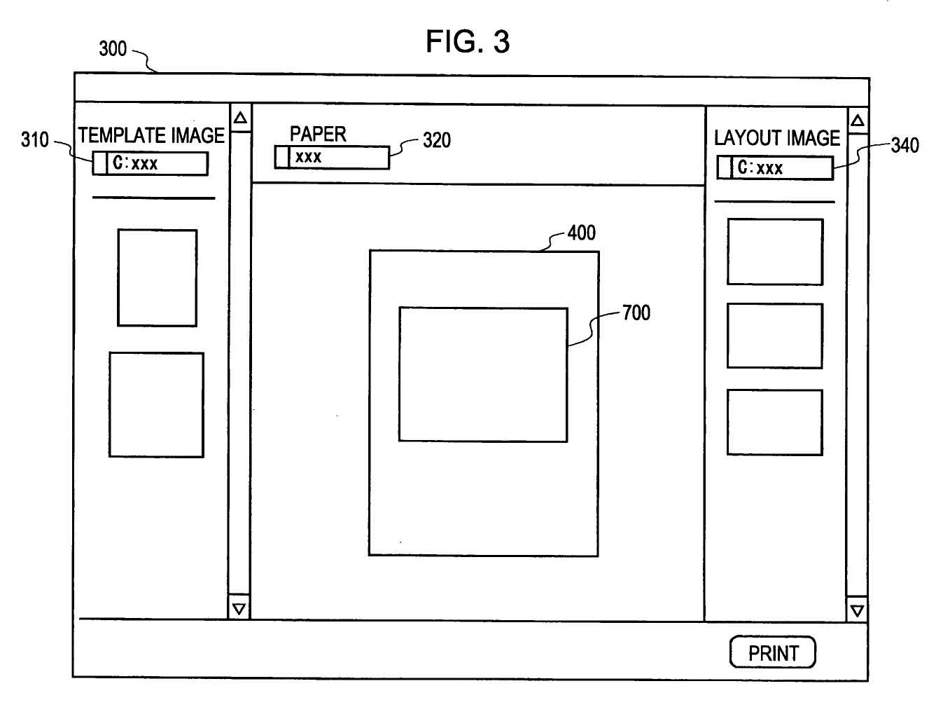

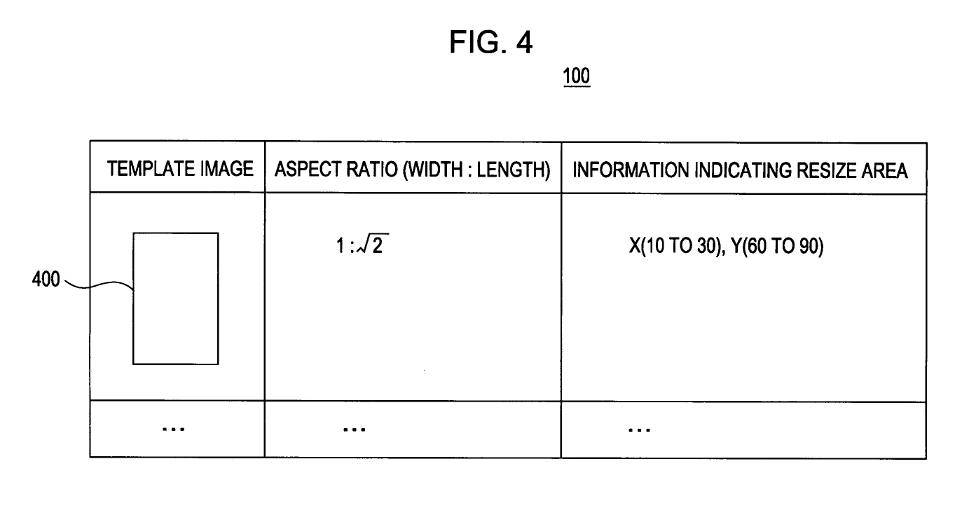

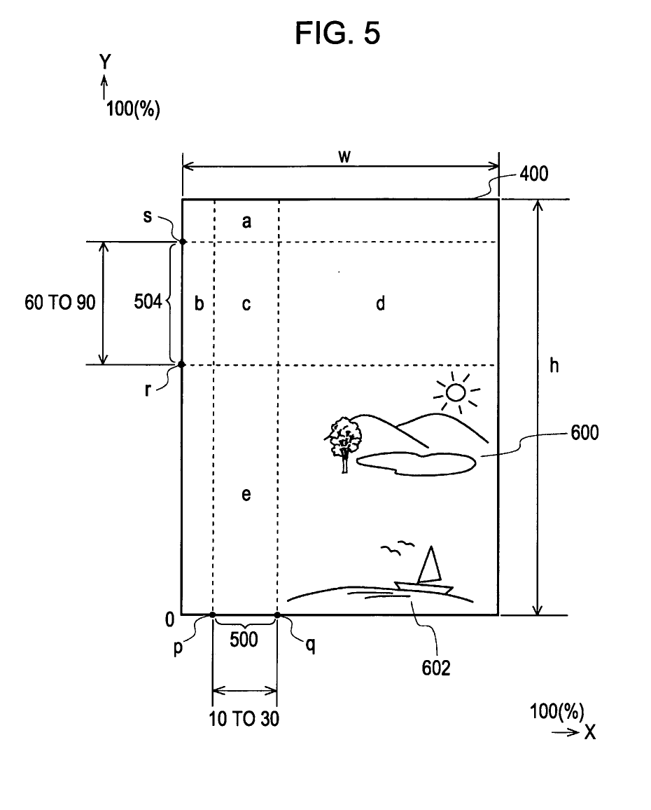

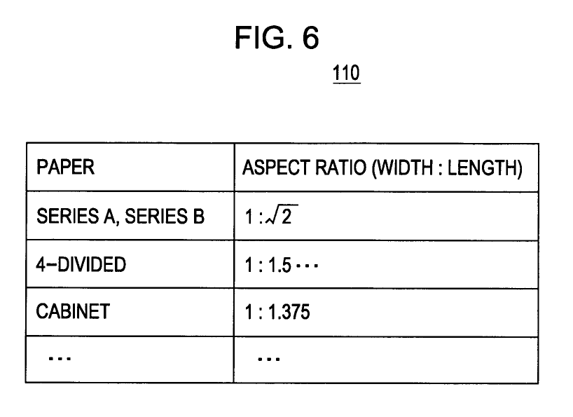

FIG. 2 is an example of a block diagram of the personal computer 10. FIG. 3 shows an example of the display content of a window 300 according to an embodiment of the invention. FIG. 4 shown an example of information stored in a template image storing unit 100 according to an embodiment of the invention. FIG. 5 schematically shows a template image and a resize area of the template image according to an embodiment of the invention. FIG. 6 shows an example of information stored in a paper aspect ratio storing unit 110 according to an embodiment of the invention. The personal computer 10, as shown in FIG. 2, includes a template image storing unit 100, the paper aspect ratio storing unit 110, a layout image storing unit 120, a template image designating unit 130, a paper designating unit 140, a resized template image generating unit 150, and a layout image designating unit 160. The personal computer 10 displays the window 300 shown in FIG. 3 on the display 14.

In the template image storing unit 100, a template image, an aspect ratio which is a ratio of the vertical length of the template image to the horizontal length, and information representing a resize area (hereinafter, referred to as a resize area) which is an area in which the template image is expanded or contracted in the vertical or horizontal direction are stored in correspondence with one another. For example, in the example shown in FIG. 4, the template image storing unit 100 stores the aspect ratio of “1:√2” and information representing a resize area of “X(10 to 30), Y(60 to 90)” in correspondence with the template image 400. In particular, as shown in FIG. 4, the aspect ratio of “width:length” is stored in the template image storing unit 100. However, the aspect ratio of “horizontal length:vertical length” instead of the “width:length” may be stored in the template image storing unit 100.

The information “X(x1 to x2)” representing the resize area which is stored in the template image storing unit 100 represents a resize area which is defined by a start point “x1 (%)” and an end point “x2 (%)” in a case where the whole length of the template image in the horizontal direction is set to be 100% and divides the template image in the vertical direction. In particular, in the example shown in FIG. 5, the information “X(10 to 30)” for representing a resize area represents a resize area 500 having areas a, c, and e which is defined by a start point p of “10%” and an end point q of “30%” in a case where the whole length w in the horizontal direction is set to be 100%. Similarly, information “Y(y1 to y2) for representing a resize area represents a resize area which is defined by a start point of “y1 (%)” and an end point of “y2(%) in a case where the whole length of the template image in the vertical direction is set to be 100% and divides the template image in the horizontal direction. In particular, in the example shown in FIG. 5, the information “Y(60 to 90)” for representing a resize area represents a resize area 504 having areas b, c and d which is defined by a start point r of “60%” and an end point s of “90%” in a case where the whole length h in the vertical direction is set to be 100%. In addition, a resize area 500 resizes the template image 400 in the horizontal direction, and a resize area 504 resizes the template image 400 in the vertical direction.

In the template image storing unit 100, in the example shown in FIG. 5, as information representing a resize area that resizes the template image 400 in the horizontal direction, although information representing one resize area 500 is stored, however, information representing a plurality of resize areas resizing the template image 400 in the horizontal direction may be stored therein. Similarly, in the template image storing unit 100, as information representing a resize area that resizes the template image 400 in the vertical direction, although information representing one resize area 504 is stored, however, information representing a plurality of resize areas resizing the template image 400 in the vertical direction may be stored therein.

In addition, in the template image storing unit 100, in the example shown in FIG. 5, although information representing resize areas 500 and 504 which are parts of the template image 400 is stored, however, information representing a resize area that is the whole area of the template image 400 may be stored therein. For example, in the template image storing unit 100, information of “X(0 to 100)” or information of “Y(0 to 100) representing a resize area that is the whole area of the template image 400 is stored.

The resize area is set for each template, for example, by a manufacturer of the template image. When a resize area is to be set for a template image, if an image such as a character that is required not to be transformed by resizing is drawn on the template image, it is preferable that an area excluding the image is set to be a resize area. For example, in the example shown in FIG. 5, in the template image 400, areas excluding areas in which characters 600 and 602 are drawn are set to be resize areas 500 and 504. However, when a resize area is to be set in a template image, an area excluding an area in which the layout image of the template image is laid out may be set as a resize area.

In the paper aspect ratio storing unit 110, the aspect ratios of paper are stored in correspondence with the types of paper to be printed by the printer 20. For example, in the example shown in FIG. 6, in the paper aspect ratio storing unit 110, an aspect ratio of “1:√2” and the like are stored in correspondence with paper of “A series or B series”. In the layout image storing unit 120, a layout image is stored. In the paper aspect ratio storing unit 110, an aspect ratio of “width:length” is stored in a case where the aspect ratio of “width length” is stored in the template image storing unit 100. On the other hand, an aspect ratio of “horizontal length:vertical length” is stored in the paper aspect ratio storing unit 110 in a case where the aspect ratio of “horizontal length:vertical length” is stored in the template image storing unit 100.

The template image designating unit 130 receives designation of a template image stored in the template image storing unit 100 and displays the designated template image on the display 14. In the example shown in FIG. 3, the template image designating unit 130 receives designation of one template image 400 through the template image designation area 310 from among a plurality of template images stored in the template image storing unit 100 and displays the designated template image on the display 14.

The paper designating unit 140 receives designation of the type of paper to be used by the printer 20. In the example shown in FIG. 3, the paper designating unit 140 receives designation of the type of paper through a paper designation area 320.

The layout image designating unit 160 receives designation of a layout image stored in the layout image storing unit 120 and lays out the designated layout image on the template image for display. In the example shown in FIG. 3, the layout image designating unit 160 receives designation of one layout image 700 through a layout image designation area 340 from among a plurality of layout images stored in the layout image storing unit 120 and lays out the designated layout image on the template image 400 for display.

The resized template image generating unit 150 calculates at least one resize ratio between a vertical resize ratio and a horizontal ratio for matching the aspect ratio of the template image of which designation is received by the template image designating unit 130 to the aspect ratio of the paper of which designation is received by the paper designating unit 140 and resizes the resize area of the template image, and thereby generating a template image (hereinafter, referred to as a resized template image) in which the vertical length or horizontal length of the template image is resized in accordance with the resize ratio by resizing the resize area of the template image. The template image designating unit 130 displays the resized template image generated by the resized template image generating unit 150 on the display 14.

When the template image on which the layout image is laid out by the layout image designating unit 160 is displayed on the display 14, it is preferable that the resized template image generating unit 150 does not resize the layout image. For example, in a case where the layout image is laid out in the resize area of the template image, the resized template image generating unit 150 generates a resized template image in which the vertical length or horizontal length of the template image is resized in accordance with the calculated resize ratio by resizing the resize area of the template image without resizing the layout image when designation of the type of paper is received by the paper designating unit 140. In addition, for example, in a case where a layout image is laid out in a resize area of the template image having a plurality of resize areas, when designation of the type of paper is received by the paper designating unit 140, the resized template image generating unit 150 may generate a resized template image in which the vertical length of horizontal length of the template image is resized in accordance with the calculated resize ratio by resizing resize areas, in which the layout image is not laid out, among the plurality of resize areas. When the resized template image is generated by the resized template image generating unit 150, the template image designating unit 130 displays the resized template image, on which the layout image is laid out, on the display 14.

In a storage medium 70, application software (hereinafter, referred to as “main image processing software”) relating to an image process for performing operations of the template image storing unit 100, the paper aspect ratio storing unit 110, the layout image storing unit 120, the template image designating unit 130, the paper designating unit 140, the resized template image generating unit 150, and the layout image designating unit 160 is stored. The personal computer 10 may allow the resized template image generating unit 150 and the like to perform operations by installing the main image processing software stored in the storage medium 70. In addition, as another method, the personal computer 10 may acquire the main image processing software through a network.

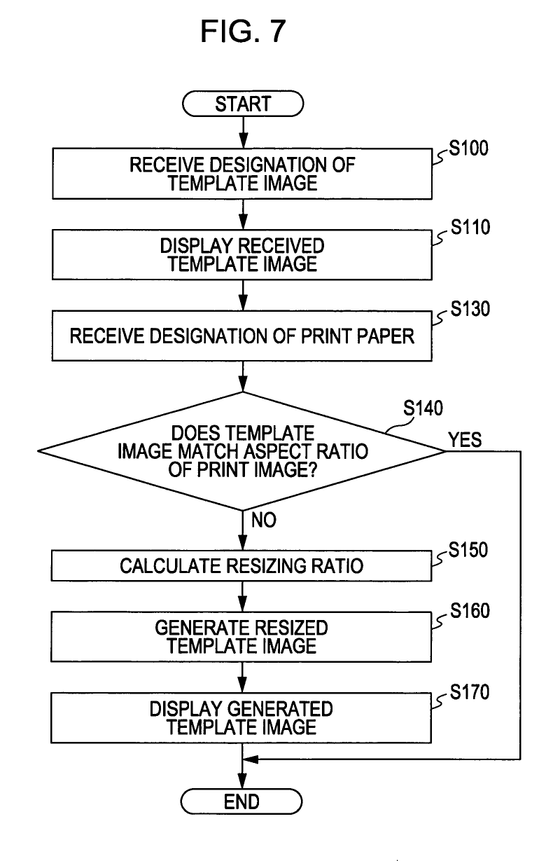

FIG. 7 is a flowchart showing an example of the operation of the personal computer 10. The process in the flowchart shown in FIG. 7 is started as the template image designating unit 130 receives designation of a template image stored in the template image storing unit 100 (S100). At the start of the flowchart, it is assumed that information shown in FIG. 5 is stored in the template image storing unit 100. In addition, in the paper aspect ratio storing unit 110, it is assumed that information shown in FIG. 6 is stored.

Following Step S100, the template image designating unit 130 reads out the template image for which designation has been received from the template image storing unit 100 and displays the template image (S110). In addition, the template image designating unit 130 acquires and temporarily stores the aspect ratio of the template image and information representing a resize area which are stored in the template image storing unit 100 in correspondence with the template image.

The paper designating unit 140 receives designation of the type of paper that can be used for the printer 20 (S130). The paper designating unit 140 acquires and temporarily stores the aspect ratio of the paper which is stored in the paper ratio storing unit 110 in correspondence with the paper.

The resized template image generating unit 150 acquires the aspect ratio of the template image temporarily stored in the template image designating unit 130 and the aspect ratio of the paper temporarily stored in the paper designating unit 140 and determines whether the aspect ratio of the template image and the aspect ratio of the paper are matched with each other (S140).

When determining that the aspect ratio of the template image and the aspect ratio of the paper are not matched to each other in Step S140 (S140: No), the resized template image generating unit 150, first, calculates at least one resize ratio between the vertical resize ratio and the horizontal resize ratio that match the aspect ratio of the template image to the aspect ratio of the paper (S150). Then, the resized template image generating unit 150 generates a resized template image in which the vertical length or the horizontal length of the template image is resized in accordance with the resize ratio calculated in Step S150 by resizing the resize area represented by information representing the resize area which is temporarily stored in the template image designating unit 130 (S160). After Step S160, the template image designating unit 130 displays the resized template image generated in Step S160, instead of the template image displayed in Step S110, on the display 14 (S170). Then, the process shown in the flowchart is completed.

On the other hand, when determining that the aspect ratio of the template image and the aspect ratio of the paper are matched to each other in Step S140 (S140: Yes), the resized template image generating unit 150 skips Steps from S150 to S170, and the process shown in the flowchart is completed.

Accordingly, according to the process shown in this flowchart, one template image can be commonly used for paper sheets having different aspect ratios. Thus, a plurality of templates of a same form or a same background for each size of paper or each aspect ratio is not required to be stored, and therefore, it is possible to save the amount of a disk by reducing the number of processes for generating and maintaining template images.

In the process shown in this flowchart, the layout image designating unit 160 may be configured to receive designation of a layout image and display the layout image laid out on the template image displayed in Step S110. When the designation of the layout image is received by the layout image designating unit 160, in Step S160, the resized template image generating unit 150 generates the resized template image without resizing a layout image in a case where the layout image is laid out on the template image. Subsequently in Step S170, the template image designating unit 130 displays the generated resized template image on the display 14. Subsequently, the template image designating unit 130 lays out the layout image on the resized template image and displays the resultant image on the display 14. In Step S160, when the layout image is laid out in the resize area, the resized template image generating unit 150 may generate the resized template image after excluding the layout image from the resize area. In addition, for example, when the template image has a plurality of resize areas, the resized template image generating unit 150 may generate the resized template image by resizing a resize area, in which the layout image is not laid out, among the plurality of resize areas. Accordingly, the resized template image can be generated in a speedy manner.

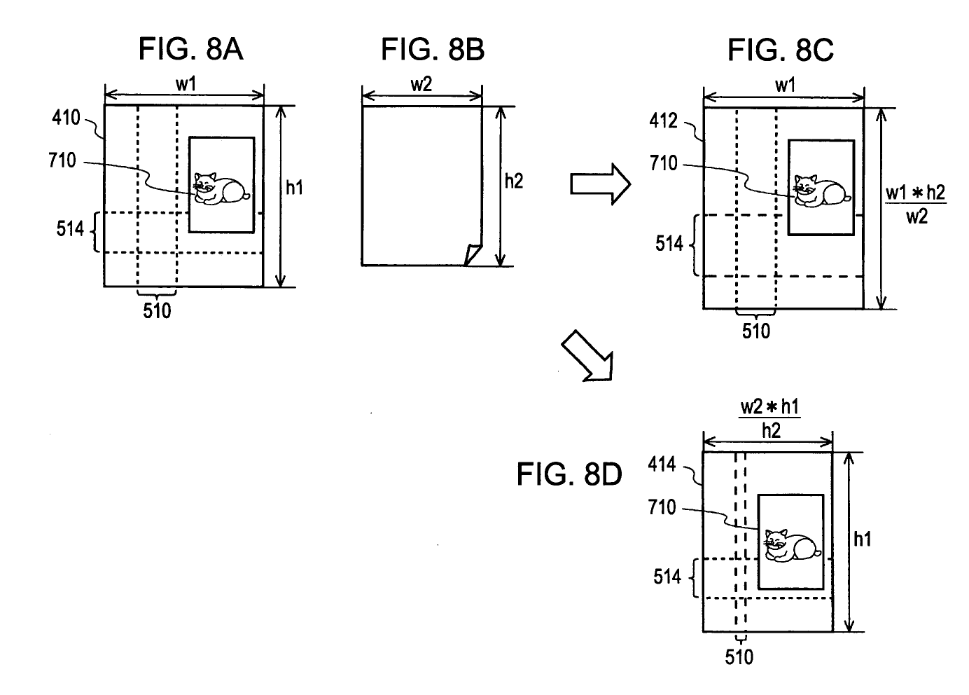

FIGS. 8A to 8D schematically show a template image and resize areas of the template image respectively according to an embodiment of the invention. Hereinafter, the process shown in the flowchart of FIG. 7 will be described in details with reference to FIG. 8. In Step S100, the template image designating unit 130 receives designation of a template image 410, shown in FIG. 8A, having the vertical length of “h1” and the horizontal length of “w1”. Then, in Step S130, when the paper designating unit 140 receives designation of paper, shown in FIG. 8B, having an aspect ratio of “w2/h2” different from the aspect ratio “w1/h1” of the template image 410, first, the resized template image generating unit 150 calculates a resize ratio “(w1*h2)/(w2*h1)” for matching the aspect ratio “w1/h1” of the template image 410 to the aspect ratio “w2/h2” of the paper (S150). Subsequently, the resized template image generating unit 150 generates a resized template image 412 shown in FIG. 8C in which the vertical length “h1” of the template image 410 is elongated in accordance with a resize ratio of “(w1*h2)/(w2*h1)” by elongating a resize area 514 of the template image 410 (S160). The generated resized template image 412, as shown in FIG. 8C, has the vertical length of “(w1*h2)/w2” and the horizontal length of “w1”. The resize area 514 of the resized template image 412 is enlarged as shown by dotted lines, and the layout image 710 is laid out without being elongated.

Alternatively, the resized template image generating unit 150 may generate a resized template image 414, shown in FIG. 8D, which is generated from shortening the vertical length “w1” of the template image 410 in accordance with the resize ratio of “(w2*h1)/(w1*h2)” by shortening a resize area 510 of the template image 410, instead of elongating the resize area 514 of the template image 410 (S160). The generated resized template image 414, as shown in FIG. 8D, has the vertical length of “h1” and the horizontal length of “(w2*h1)/h2”. In addition, the resize area 510 is contracted in the resized template image 414 as shown by dotted lines, and the layout image 710 is laid out without being elongated.

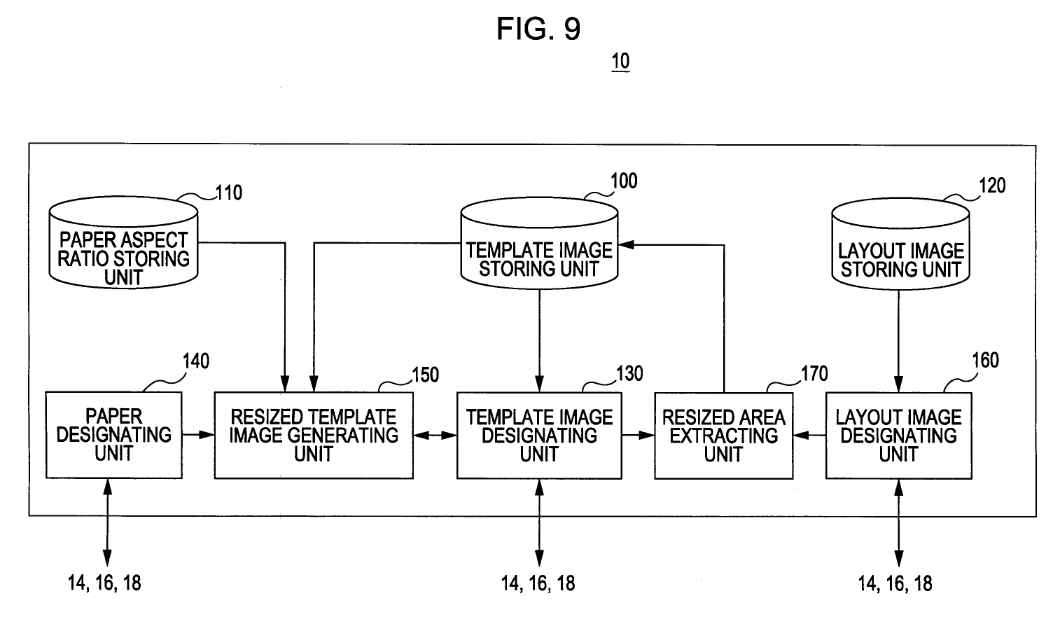

FIG. 9 shows another block diagram of the personal computer 10. The personal computer 10, as shown in FIG. 9, further includes a resize area extracting unit 170 in addition to the template image storing unit 100, the paper aspect ratio storing unit 110, the layout image storing unit 120, the template image designating unit 130, the paper designating unit 140, the resized template image generating unit 150, and the layout image designating unit 160.

The resize area extracting unit 170 extracts a resize area of a template image when designation of the template image not having information representing the resize area is received by the template image designating unit 130. The resize area extracting unit 170, for example, may extract an area excluding an image as a resize area in a case where the image such as a character of which deformation due to resizing is not wanted is drawn on the template image. In addition, for example, the resize area extracting unit 170 may extract an area excluding an area in which the layout image of the template image is laid out as a resize area. The resize area extracting unit 170 stores information representing the extracted resize area in the template image storing unit 100 in correspondence with the template image. In other words, in the template image storing unit 100 of the personal computer 10 shown in FIG. 9, a template image in which a resize area is not set can be stored in addition to a template image in which the resize area is set in advance. Accordingly, a user's favorite image can be used as the template image without the resize area set by the user.

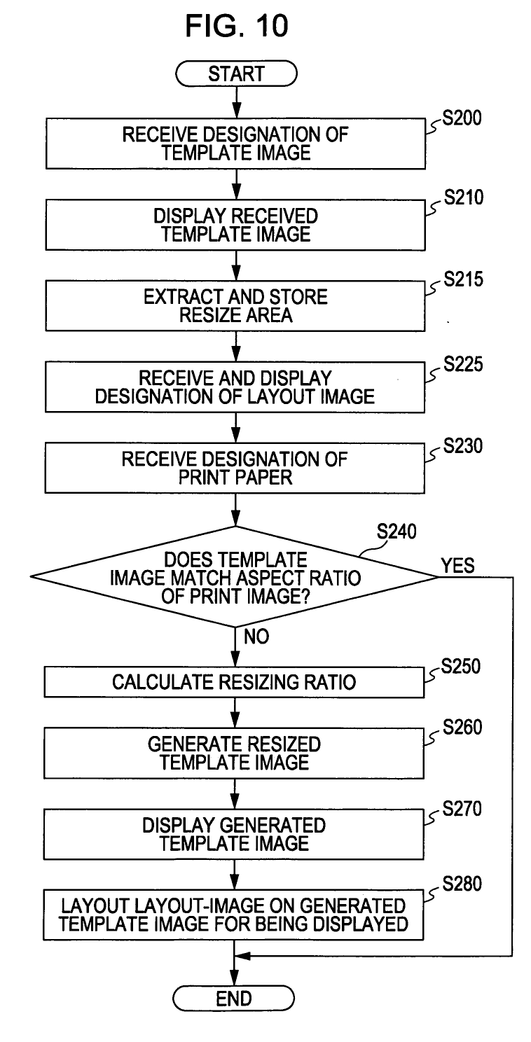

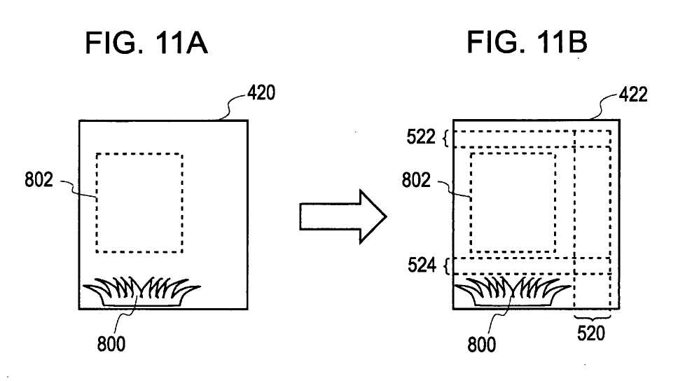

FIG. 10 is a flowchart showing an example of another operation of the personal computer 10. FIGS. 11A and 11B schematically show a template image and resize areas of the template image respectively according to an embodiment of the invention. The process shown in the flowchart of FIG. 10 is started as the template image designating unit 130 of the personal computer 10 shown in FIG. 9 receives designation of a template image stored in the template image storing unit 100 (S200). At the start of the process shown in this flowchart, it is assumed that information shown in FIG. 6 is stored in the paper aspect ratio storing unit 110.

After Step S200, the template image designating unit 130 reads out the template image, of which designation has been received, from the template image storing unit 100 and displays the template image (S210). For example, the template image designating unit 130 reads out a template image 420, as shown in FIG. 11A, in which a resize image is not designated from the template image storing unit 100 and displays the template image 420. In addition, the template image designating unit 130 acquires and temporarily stores the aspect ratio of the template image which is stored in the template image storing unit 100 in correspondence with the template image.

The resize area extracting unit 170 extracts an area in which an image such as a character whose deformation due to resizing is not wanted is drawn, from the template image of which designation has been received in Step 200, by using a known technique such as a feature point detection method (S215). The resize area extracting unit 170 extracts an area excluding the extracted area in which an image whose deformation due to resizing is not wanted is drawn and the area in which the layout image is laid out as a resize area (same step). For example, in the example shown in FIG. 11B, the resize area extracting unit 170 extracts areas excluding the area 800 of the template image 420 in which the image whose deformation due to resizing is not wanted is drawn and the area 802 in which the layout image is laid out as resize areas 520 and 522. Then, the resize area extracting unit 170 stores information representing the extracted resize areas in the template image storing unit 100 in correspondence with the template image (same step). The template image designating unit 130 acquires the information representing the resize areas of the template image which is stored in the template image storing unit 100.

The layout image designating unit 160 receives designation of a layout image, lays out the layout image on the template image, and displays the resultant image (S225). The paper designating unit 140 receives designation of the type of paper used for the printer 20 (S230). The paper designating unit 140 acquires and temporarily stores the aspect ratio of the paper which is stored in the paper aspect ratio storing unit 110 in correspondence with the paper.

The resized template image generating unit 150 determines whether the aspect ratio of the template image and the aspect ratio of the paper are matched to each other (S240). Operations from Step S250 to Step S270 performed when the resized template image generating unit 150 determines that the aspect ratio of the template image and the aspect ratio of the paper are not matched to each other in S240 (S240: No) are the same as those from Step S150 to Step S170 shown in FIG. 7, and thus a description thereof is omitted here. After Step S270, the layout image designating unit 160 displays the layout image of which designation has been received in Step S225 on the resized template image generated in Step S260 (S280). Then, the process shown in this flowchart is completed. On the other hand, when the resized template image generating unit 150 determines that the aspect ratio of the template image and the aspect ratio of the paper are matched to each other in S240 (S240: Yes), Steps S250 to S280 are skipped, and then, the process shown in this flowchart is completed.

As described above, according to the process shown in this flowchart, a template image can be resized even in a case where the template image is stored without designation of a resize area and used for paper sheets having different aspect ratios.

When the template image designating unit 130 receives designation of the template image again in Step S200 after the resize area extracting unit 170 extracts and stores the resize area of the template image in Step S215, Step S215 is not required to be performed again. When the resize area extracting unit 170 does not perform Step S215 again, for example, the template image designating unit 130 acquires and temporarily stores the aspect ratio of the template image and the information representing the resize area stored in advance in Step S200 again.

As described above, according to this embodiment, a template of any aspect ratio can be commonly used for paper sheets having different aspect ratios. Thus, there is no need for storing templates of a same format or a same background for each size of paper or each aspect ratio, and, accordingly, it is possible to save the capacity of the disk by reducing the number of processes for generating and maintaining the templates.

Although embodiments of the present invention have been described, the technical scope of the invention is not limited thereto. It is apparent to those skilled in the art that various changes or modifications can be made in the above-described embodiments. It is apparent from the following claims that such changed or modified embodiments belong to the technical scope of the invention.

What is claimed is:

1. An image processing apparatus that lays out a layout image on a template image and outputs a resultant image to a print device, the image processing apparatus comprising:
a template image storing unit that stores the template image, the aspect ratio of the template image, and information representing a resize area that is a part or the whole of the area of the template image and resizes the template image in the vertical or horizontal direction are stored in correspondence with one another;
a paper aspect ratio storing unit that stores the aspect ratio of paper in correspondence with the type of the paper used by the print device;
a template image designating unit that receives designation of the template image stored in the template image storing unit and displays the designated template image on a display screen;
a paper designating unit that receives designation of the type of the paper used for the print device; and
a resized template image generating unit that generates a resized template image in which the vertical or horizontal length of the template image is resized in accordance with a resize ratio by calculating at least one resize ratio between a vertical resize ratio and a horizontal resize ratio for matching the aspect ratio of the template image of which designation has been received by the template image designating unit to the aspect ratio of the paper of which designation has been received by the paper designating unit and resizing the resize area of the template image;
wherein the template image designating unit displays the resized template image generated by the resized template image generating unit on the display screen.

2. The image processing apparatus according to claim 1, further comprising a resize area extracting unit that extracts the resize area of the template image and stores information representing the extracted resize area in the template image storing unit in correspondence with the template image in a case where the designation of the template image that does not have the information representing the resize area has been received by the template image designating unit,
wherein the template image storing unit additionally stores a template image that does not have information representing the resize area.

3. The image processing apparatus according to claim 2, wherein the resize area extracting unit extracts an area in which the layout image is not laid out as the resize area.

4. The image processing apparatus according to claim 1,
wherein the resizing template image generating unit generates the resized template image in which the vertical length or horizontal length of the template image is resized in accordance with the resize ratio by resizing the resize area of the template image when designation of the paper is received by the paper designating unit in a case where the template image on which the layout image is laid out is displayed on the display screen, and
wherein the template image designating unit displays the resized template image on which the layout image without resizing is laid out on the display screen.

5. The image processing apparatus according to claim 1,
wherein the template image storing unit stores information representing a plurality of resize areas in correspondence with the template image,
wherein the resized template image generating unit generates the resized template image in which the vertical length or horizontal length of the template image is resized in accordance with the resize ratio by resizing a resize area of the template image, from among the plurality of resize areas, on which the layout image is not laid out when designation of the paper is received by the paper designating unit in a case where the template image on which the layout image is laid out is displayed on the display screen, and
wherein the template image designating unit displays the resized template image on which the layout image is laid out on the display screen.

6. An image processing method for laying out a layout image on a template image and outputting a resultant image to a print device, the image processing method comprising:
storing the template image, the aspect ratio of the template image, and information representing a resize area that is a part or the whole of the area of the template image and resizes the template image in the vertical or horizontal direction are stored in correspondence with one another;
storing the aspect ratio of paper in correspondence with the type of the paper used by the print device;
receiving designation of the template image stored in accordance with the storing of the template image and displaying the designated template image on a display screen;
receiving designation of the type of the paper used for the print device; and
generating a resized template image in which the vertical or horizontal length of the template image is resized in accordance with a resize ratio by calculating at least one resize ratio between a vertical resize ratio and a horizontal resize ratio for matching the aspect ratio of the template image of which designation has been received by the receiving designation of the template image to the aspect ratio of the paper of which designation has been received by the receiving designation of the type of the paper and resizing the resize area of the template image;
wherein the receiving designation of the template image displays the resized template image generated by the generating of a resized template image on the display screen.

7. A recording medium, comprising a program for controlling an image processing apparatus that lays out a layout image on a template image and outputs a resultant image to a print device, the program being recorded on the recording medium, wherein the program allows the image processing apparatus to perform:
a template image storing sequence for storing the template image, the aspect ratio of the template image, and information representing a resize area that is a part or the whole of the area of the template image and resizes the template image in the vertical or horizontal direction are stored in correspondence with one another;
a paper aspect ratio storing sequence for storing the aspect ratio of paper in correspondence with the type of the paper used by the print device;
a template image designating sequence for receiving designation of the template image stored in accordance with the template image storing sequence and displaying the designated template image on a display screen;
a paper designating sequence for receiving designation of the type of the paper used for the print device; and
a resized template image generating sequence for generating a resized template image in which the vertical or horizontal length of the template image is resized in accordance with a resize ratio by calculating at least one resize ratio between a vertical resize ratio and a horizontal resize ratio for matching the aspect ratio of the template image of which designation has been received by the template image designating sequence to the aspect ratio of the paper of which designation has been received by the paper designating sequence and resizing the resize area of the template image;
wherein the template image designating sequence displays the resized template image generated by the resized template image generating sequence on the display screen.
